(19) United States
(12) Patent Application Publication
(10) Pub. No.: US 2003/0031404 A1
(43) Pub. Date: Feb. 13, 2003

(54) Optical transmission systems including optical components and optical filters and methods of use therein

(75) Inventor: Bo Pedersen, Annapolis, MD (US)

Correspondence Address: CORVIS CORPORATION, INTELLECTUAL PROPERTY DEPARTMENT, 7015 ALBERT EINSTEIN DRIVE, COLUMBIA, MD, 210469400

(73) Assignee: Corvis Corporation

(21) Appl. No.: 09/923,909

(22) Filed: Aug. 7, 2001

(51) Int. Cl. G02B 6/28; G02B 6/26

(52) U.S. Cl. 385/24; 385/15

(57) ABSTRACT

Optical transmission systems of the present invention includes at least one double pass Mach Zehnder filter, which includes a first optical coupling section coupling at least one input/output port to a first end of two or more optical communication paths, or Mach-Zehnder legs, having different effective lengths. A second optical coupling section is provided to couple at least one output/input port to a second end of the optical communication paths. The first and second optical coupling sections and the two communication paths form a Mach-Zehnder interferometer. The double pass Mach-Zehnder filter is configured such that the output from at least one of the output/input port is coupled back into one of the one output/input ports and passes through the Mach-Zehnder interferometer a second time.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention is directed generally to optical systems. More particularly, the invention relates to optical WDM systems and optical components employing Mach-Zehnder filters, and methods of making and using such filters therein.

The continued growth in traditional communications systems and the emergence of the Internet as a means for accessing data has accelerated demand for high capacity communications networks. Telecommunications service providers, in particular, have looked to wavelength division multiplexing (WDM) to increase the capacity of their existing systems to meet the increasing demand.

In WDM transmission systems, information is transmitted using pluralities of electromagnetic waves at distinct wavelengths, or information carrying wavelengths, in the optical spectrum, typically in the infrared wavelength range. Each information carrying wavelength can carry a single data stream or multiple data stream that are electrically or optically time division multiplexed (“TDM”) together into a TDM data stream.

The pluralities of information carrying wavelengths are combined into a multiple wavelength, “WDM”, optical signal that is transmitted in a single waveguide. In this manner, WDM systems can increase the transmission capacity of existing space division multiplexed (“SDM”), i.e., single channel, systems by a factor equal to the number of wavelengths used in the WDM system.

One difficulty that exists with WDM systems is that the various signal wavelengths often have to be separated for routing/switching during transmission and/or reception at the signal destination. In early WDM systems, the wavelength spacing was limited, in part, by the ability to effectively separate wavelengths from the WDM signal at the receiver. Most optical filters in early WDM systems employed wide pass band filters, which effectively set the minimum spacing of the wavelengths in the WDM system.

Various tunable or fixed, high, low, or band pass or stop, transmissive or reflective filters, such as Bragg gratings, Fabry-Perot, Mach-Zehnder, and dichroic filters, etc. have been developed to address the need to separate wavelengths in WDM systems. These filters are deployed alone or in combination with various optical combiners and distributors, such as passive or WDM couplers/splitters, arrayed waveguides, circulators, dichroic devices, prisms, diffraction gratings, etc., as well as with isolators in various components and systems depending upon the desired application. The filters, combiners, distributors, and isolators can be deployed in various configurations, such as in one or more serial or parallel stages incorporating various devices to multiplex, demultiplex, and multicast signal wavelengths.

Many filtering devices, such as Mach-Zehnder, Fabry-Perot, arrayed waveguides, etc., have a periodic transmission properties that can be used to perform a filter function. The applicability of these filters depends upon the transmission properties associated with the filter function. For example, the ability of the filter to separate adjacent channels, thereby providing channel isolation and limiting crosstalk between the channels in the separation process will dictate the applications for which the filters are suitable.

Numerous variations of these filters have been developed in an attempt to improve transmission properties, such as channel isolation and crosstalk. For example, U.S. Pat. Nos. 3,936,144, 4,900,119, 5,309,534, 5,719,976, 5,978,114, and 5,946,432, all discloses various embodiments of Mach-Zehnder filters alone or in combination with other filters, such as Bragg gratings.

The continuing interest in developing new filters with improved filtering characteristics is based on the recognition that wavelength separation technology still poses a limitation to the development of higher performance, lower cost communication systems. As such, there is a need to improve continually the optical filters and filtering methods available for use in optical components, subsystems and systems.

### BRIEF SUMMARY OF THE INVENTION

The apparatuses and methods of the present invention address the above need for improved optical transmission systems and optical filters for use therein. Optical transmission systems of the present invention include at least one double pass Mach Zehnder (“DPMZ”) filter, which may be used in various applications within the system.

The double pass Mach-Zehnder filter includes a first optical coupling section coupling at least one input/output port to a first end of two or more optical communication paths, or Mach-Zehnder legs, having different effective lengths. A second optical coupling section is provided to couple at least one output/input port to a second end of the optical communication paths. The first and second optical coupling sections and two of the communication paths form a Mach-Zehnder interferometer. The double pass Mach-Zehnder filter is configured such that the output from at least one of the output/input port is coupled back into one of the one output/input ports and passes through the Mach-Zehnder interferometer a second time.

The difference in the Mach-Zehnder legs introduces a path length mismatch such that optical energy coupled to the input/output ports is coupled to at least one of the first and second output/input port according to a desired filter function. The first and second output/input ports are coupled such that optical energy exiting at least one of the output/input ports is provided as an input to at least one the output/input ports. Optical energy that enters the output/input ports passes through the Mach-Zehnder interferometer and exits the filter via at least one of the input/output ports.

In various embodiments, an isolator, a circulator, or other wavelength or non-wavelength selective isolation and/or reflective device introduces optical energy exiting the output/input ports as a second pass input back into the output/input ports. The second pass input passes through the Mach-Zehnder interferometer and is filtered a second time. It will be appreciated that multiple Mach-Zehnder stages can be provided to perform various filter functions.

The Mach-Zehnder interferometer can have a fixed path length mismatch or it can be tunable depending upon the particular application for the filter. For example, various tuning methods, such as temperature, strain, electric and magnetic fields, etc., can be used to maintain, change, and/or otherwise control the filter function.

The device of the present invention can be used in various components and subsystems within a system. For example, the device can be used to perform filtering functions in various components, subsystems, and network elements, including transmitters, receivers, multiplexers, demultiplexers, switches, add/drop multiplexers, etc. In all-optical network or subnetwork embodiments, the device can be used to perform tunable or fixed wavelength filtering. As such, networks employing the tunable filter 40 in combination with various optical components, such as transmitters, receivers, and optical switching devices, can support reconfigurable transmission paths for the signal wavelengths through the network.

The present invention addresses the limitations of the prior art by providing filtering devices and methods that can provide increased control and flexibility necessary for higher performance, lower cost optical transmission systems. These advantages and others will become apparent from the following detailed description.

### BRIEF DESCRIPTION OF THE DRAWINGS

Embodiments of the present invention will now be described, by way of example only, with reference to the accompanying schematic drawings for the purpose of illustrating embodiments only and not for purposes of limiting the same, wherein:

FIGS. 1 and 2 illustrate optical system embodiments;

FIG. 3-4 illustrates double pass Mach-Zehnder filter embodiments;

FIG. 5 illustrates single and double pass Mach-Zehnder filter spectral response profiles;

FIGS. 6-11 illustrate double pass Mach-Zehnder filter embodiments; and,

FIG. 12 illustrates an optical receiver double pass Mach-Zehnder filter application.

### DESCRIPTION OF THE INVENTION

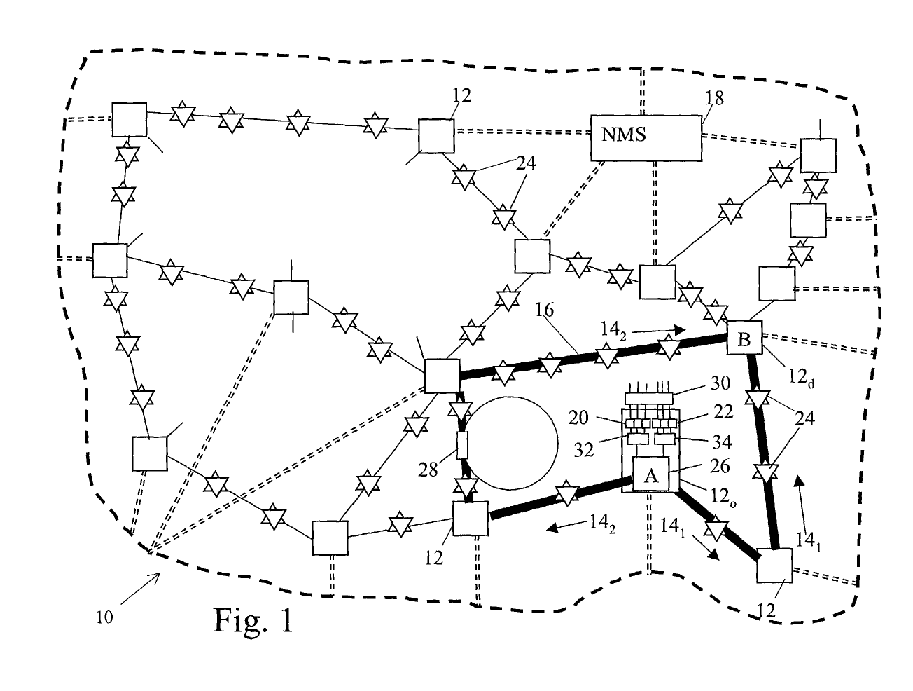

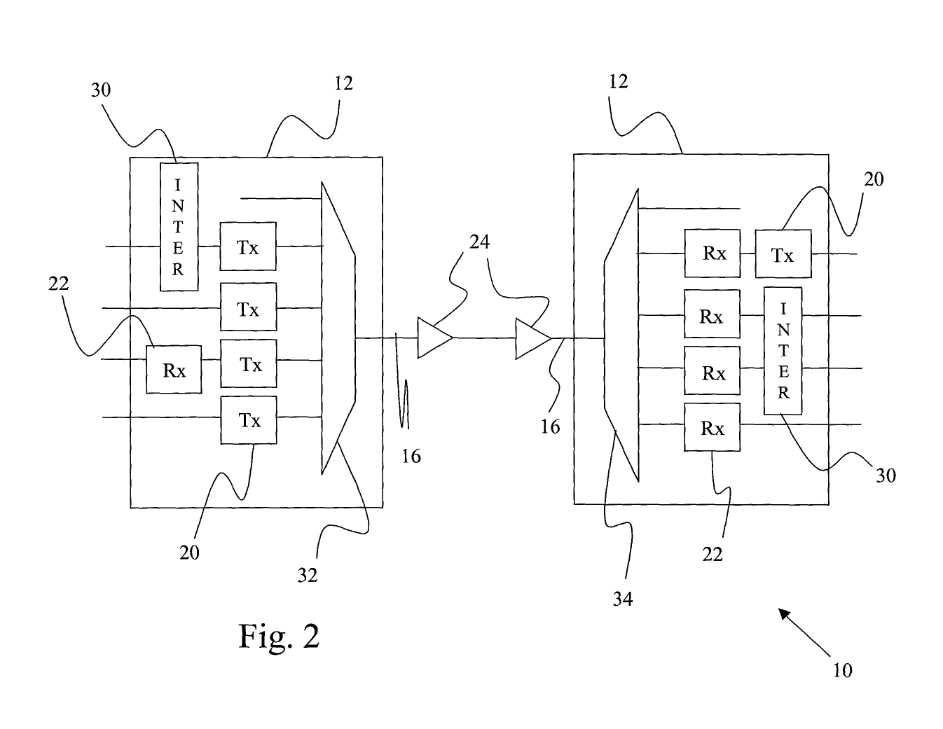

FIG. 1 illustrates an optical system 10, which includes a plurality of nodes 12 connected by optical communication paths 14. Advantages of the present invention can be realized with many system 10 configurations, topologies, and architectures. For example, an all optical network, one or more interconnected point to point optical links (FIG. 2), and combinations thereof can be configured in various topologies, i.e., rings, mesh, etc. to provide a desired network connectivity.

The system 10 can support one or more transmission schemes, such as space, time, polarization, code, wavelength and frequency division multiplexing, etc., singly or in combination within a network to provide communication between the nodes 12. The system 10 can include various types of transmission media 16 and be controlled by a network management system 18.

As shown in FIG. 1, optical processing nodes 12 generally can include one or more optical components, such as transmitters 20, receivers 22, amplifiers 24, optical switches 26, optical add/drop multiplexers 28, and interfacial devices 30. For example, in WDM embodiments, the node 12 can include optical switches 26 and interfacial devices 30 along with multiple transmitters 20, receivers 22, and associated equipment, such as monitors, power supplies, system supervisory equipment, etc.

The optical processing nodes 12 can be configured via the network management system 18 in various topologies. The deployment of integrated transport optical switches 26, and optical add/drop multiplexers 28 as integrated switching devices in intermediate nodes 12ᵢ can provide all-optical interconnections between the transmitters 20 and receivers 22 located in non-adjacent origination and destination nodes, 12ₒ and _{d}, respectively. The use of integrated transport switching devices in the system 10 in this manner provides for distance independent all-optical networks, sub-networks, and/or nodal connections.

In various network embodiments, multiple paths, e.g., 14₁, and 14₂, can be provided between nodes 12. The optical path 14 between adjacent nodes 12 is referred to generally as an optical link. The optical communication path 14 between adjacent optical components along the link is referred to generally as a span.

Various guided and unguided transmission media 16, such as fiber, planar, and free space media, can be used to form the optical communication paths 14. The media 16 supports the transmission of information between originating nodes 12ₒ and destination nodes 12_{d} in the system 10. As used herein, the term “information” should be broadly construed to include any type of audio, video, data, instructions, or other signals that can be transmitted.

The transmission media 16 can include one or more optical fibers interconnecting the nodes 12 in the system 10. Various types of fiber, such as dispersion shifted (“DSF”), non-dispersion shifted (“NDSF”), non-zero dispersion shifted (“NZDSF”), dispersion compensating(“DCF”), and polarization maintaining (“PMF”) fibers, doped, e.g. Er, Ge, as well as others, can be deployed as transmission fiber to interconnect nodes 12 or for other purposes in the system 10. The fiber typically can support either unidirectional or bi-directional transmission of optical signals in the form of one or more information carrying optical signal wavelengths λₛᵢ, or “channels”. The optical signal channels in a particular path 14 can be processed by the optical components as individual channels or as one or more wavebands, each containing one or more optical signal channels.

Network management systems (“NMS”) 18 can be provided to manage, configure, and control optical components in the system 10. The NMS 18 generally can include multiple management layers, which can reside at one or more centralized locations and/or be distributed among the optical components in the network. The optical components can be grouped logically as network elements for the purposes of network management. One or more network elements can be established at each optical component site in the network depending upon the desired functionality in the network and management system.

The NMS 18 can be connected directly or indirectly to network elements located either in the nodes 12 or remotely from the nodes 12. For example, the NMS 18 may be directly connected to network elements serving as a node 12 via a wide area or data communication network (“WAN” or “DCN”, shown in broken lines in FIG. 1). Indirect connections to network elements that are remote to the DCN can be provided through network elements with direct connections. Mixed data or dedicated supervisory channels can be used to provide connections between the network elements. The supervisory channels can be transmitted within and/or outside the signal wavelength band on the same medium or a different medium depending upon the system requirements.

The optical transmitters 20 transmit information as optical signals via one or more signal channels λₛᵢ through the transmission media 16 to optical receivers 22 located in other processing nodes 12. The transmitters 20 used in the system 10 generally includes an optical source that provides optical power in the form of electromagnetic waves at one or more optical wavelengths. The optical source can include various coherent narrow or broad band sources, such as DFB and DBR lasers, sliced spectrum sources and fiber and external cavity lasers, as well as suitable incoherent optical sources, e.g., LED, as appropriate. The sources can have a fixed output wavelength or the wavelength can be tunable using various feedback and control techniques, such as temperature, current, and gratings or other components or means for varying the resonance cavity of the laser or output of the source.

Information can be imparted to the electromagnetic wave to produce an optical signal carrier either by directly modulating the optical source or by externally modulating the electromagnetic wave emitted by the source. Alternatively, the information can be imparted to an electrical carrier that can be upconverted, or frequency shifted, to an optical signal wavelength λₛᵢ. Electro-optic (e.g., LiNbO₃), electro-absorption, other types of modulators and upconverters can be used in the transmitters 20.

In addition, the information can be imparted using various modulation formats and protocols. For example, various amplitude modulation schemes, such as non-return to zero (NRZ), differential encoding, and return to zero (RZ) using various soliton, chirped, and pulse technologies. Various frequency, phase, and polarization modulation techniques also can be employed separately or in combination. One or more transmission protocols, such as SONET/SDH, IP, ATM, Digital Wrapper, GMPLS, Fiber Channel, Ethernet, etc. can be used depending upon the specific network application. It will be appreciated that the transmitters 20 and receivers 22 can use one or more modulation formats and transmission protocols within the network.

The optical receiver 22 used in the present invention can include various detection techniques, such as coherent detection, optical filtering and direct detection, and combinations thereof. The receivers 22 can be deployed in modules that have incorporated wavelength selective filters to filter a specific channel from a WDM signal or channel filtering can be performed outside of the receiver module. It will be appreciated that the detection techniques employed in the receiver 22 will depend, in part, on the modulation format and transmission protocols used in the transmitter 20.

Generally speaking, N transmitters 20 can be used to transmit M different signal wavelengths to J different receivers 22. Also, tunable transmitters 20 and receivers 22 can be employed in the optical nodes 12 in a network, such as in FIG. 1. Tunable transmitters 20 and receivers 22 allow system operators and network architects to change the signal wavelengths being transmitted and received in the system 10 to meet their network requirements.

In addition, the transmitters 20 and receivers 22 can include various components to perform other signal processing, such as reshaping, retiming, error correction, differential encoding, protocol processing, etc. For example, receivers 22 can be connected to the transmitters 20 in back to back configuration as a transponder or regenerator, as shown in FIG. 2. The regenerator can be deployed as a 1R, 2R, or 3R regenerator, depending upon whether it serves as a repeater (repeat), a remodulator (reshape & repeat), or a full regenerator (reshape, retime, repeat).

In a WDM system, the transmitters 20 and receivers 22 can be operated in a uniform manner or the transmission and reception characteristics of the signal channels can be tailored individually and/or in groups. For example, pre-emphasis, optical and/or electrical pre- and post-dispersion and distortion compensation can be performed on each channel or groups of channels.

In FIG. 2, it will be appreciated that the transmitters 20 and receivers 22 can be used in WDM and single channel systems, as well as to provide short, intermediate, and/or long reach optical interfaces between other network equipment and systems. For example, transmitters 20 and receivers 22 deployed in a WDM system can be included on a module that includes standardized interface receivers and transmitters, respectively, to provide communication with interfacial devices 30, as well as other transmission and processing systems.

The optical amplifiers 24 can be deployed periodically along optical links 15 to overcome attenuation that occurs in a span of transmission media 16. In addition, optical amplifiers 24 can be provided proximate to other optical components, for example, at the node 12 as booster and/or pre-amplifiers to provide gain to overcome component losses. The optical amplifiers 24 can include doped (e.g. Er, other rare earth elements, etc.) and non-linear interaction (e.g., Raman, Brillouin, etc.) fiber amplifiers that can be pumped locally or remotely with optical energy in various configurations.

For example, optical fiber amplifier 24 generally include an amplifying fiber supplied with power in the form of optical, or “pump”, energy from one or more pump sources. The amplifying fiber can have the same or different transmission and amplification characteristics than the transmission fiber. Thus, the amplifying fiber can serve multiple purposes in the optical system, such as performing dispersion compensation, as well as different levels of amplification of the signal wavelengths λᵢ. The pump source 36 can include one or more narrow band or broad band optical sources, each providing optical power in one or more pump wavelength ranges designated by center pump wavelengths λₚᵢ and including one or more spatial and/or longitudinal modes. Pump energy can be supplied to the amplifying fiber, either counter-propagating and/or co-propagating with respect to the propagation of the signal wavelengths λᵢ.

Other types of optical amplifiers, such as semiconductor amplifiers, can be used in lieu of, or in combination with the fiber amplifiers. The optical amplifiers 24 can include one or more serial and/or parallel stages that provide localized gain at discrete sites in the network and/or gain that is distributed along the transmission media 16. Different amplifier types can be included in each stage and additional stages to perform one or more other functions. For example, optical regeneration, dispersion compensation, isolation, filtering, add/drop, switching, etc. can be included at a site along with the optical amplifier 24.

Various types of optical switching devices, both optical switches 26 and OADMs 28, can be integrated into the nodes 12 and the all-optical networking functionality of the devices can be used to establish distance independent networks. The switching devices allow for integrated optical transport switching, adding, dropping, and/or termination of signal channels from multiple paths 14 entirely in the optical domain. The switching device eliminate the need for receivers 22 and transmitters 20 to perform electrical conversions, as required when using interfacial devices 30, merely to pass the information through intermediate nodes 12ᵢ. As such, signal channels can optically pass through intermediate nodes 12ᵢ between the origin nodes 12ₒ and destination nodes 12_{d} channels, bypassing the need for transmitters 20 and receivers 22 at the intermediate nodes 12ᵢ. In this manner, the switching devices provide transparency through the node that allows all-optical express connections to be established between non-adjacent origin and destination nodes in a network.

The signal channels optically passing through the switching devices can be distributed from a common path to multiple diverse paths, as well as combined from multiple diverse paths onto a common path. It will be appreciated that signal channels that are switched onto a common path by the switching devices from different paths can have different properties, such as optical signal to noise ratio. Conversely, signal channels entering the switching devices from a common path and exiting the devices via different paths may require that the signal channels exit with different properties, such as power level. As such, signal channels may have different span loss/gain requirements or tolerances within the link 15.

The optical switches 26 and OADMs 28 can be configured to process individual signal channels or signal channel groups including one or more signal channels. The switching devices also can include various wavelength selective or non-selective switch elements, combiners 32, and distributors 34. The transmitters 20 and receivers 22 can be configured to transmit and receive signal channels dynamically through the switch elements or in a dedicated manner exclusive of the switch elements using various combiners 32 and distributors 34. The OADMs can include wavelength reusable and non-reusable configurations. Similarly, the switching devices can be configured to provide multi-cast capability, as well as signal channel terminations.

The switching devices can include various configurations of optical combiners 32 and distributors 34, such as multiplexers, demultiplexers, splitters, and couplers described below, in combination with various switch elements configured to pass or block the signals destined for the various other nodes 12 in a selective manner. The switching of the signals can be performed at varying granularities, such as line, group, and channel switching, depending upon the degree of control desired in the system 10.

The switch element can include wavelength selective or non-selective on/off gate switch elements, as well as variable optical attenuators having suitable extinction ratios. The switch elements can include single and/or multiple path elements that use various techniques, such as polarization control, interferometry, holography, etc. to perform the switching and/or variable attenuation function. The switching devices can be configured to perform various other functions, such as filtering, power equalization, dispersion compensation, telemetry, channel identification, etc., in the system 10.

Various two and three dimensional non-selective switch elements can be used in present invention, such as mechanical line, micro-mirror and other micro-electro-mechanical systems (“MEMS”), liquid crystal, holographic, bubble, magneto-optic, thermo-optic, acousto-optic, electro-optic (LiNbO₃), semiconductor, erbium doped fiber, etc. Alternatively, the switch elements can employ fixed and tunable wavelength selective multi-port devices and filters, such as those described below. Exemplary switching devices are described in PCT Application No. PCT/US00/23051, which is incorporated herein by reference.

The interfacial devices 30 may include, for example, protocol and bit rate independent devices, such as optical switches and/or protocol and bit rate dependent electrical switch devices, such as IP routers, ATM switches, SONET add/drop multiplexers, etc. The interfacial devices 30 can be configured to receive, convert, and provide information in one or more various protocols, encoding schemes, and bit rates to one or more transmitters 20, and perform the converse function for the receivers 22. The interfacial devices 30 also can be used as an input/output cross-connect switch or automated patch panel and to provide protection switching in various nodes 12 depending upon the configuration. The interfacial devices 30 can be electrically connected to the transmitters 20 and receivers 22 or optically connected using standard interface and/or WDM transmitters and receivers, as previously described.

Optical combiners 32 can be provided to combine optical signals from multiple paths into a WDM signal on a common path, e.g. fiber, such as from multiple transmitters 20 or in optical switching devices. Likewise, optical distributors 34 can be provided to distribute one or more optical signals from a common path to a plurality of different optical paths, such as to multiple receivers 22 and/or optical switching devices.

The optical combiners 32 and distributors 34 can include wavelength selective and non-selective (“passive”) fiber, planar, and free space devices, as well as polarization sensitive devices. For example, one or more multi-port devices, such as passive, WDM, and polarization couplers/splitters having various coupling/splitting ratios, circulators, dichroic devices, prisms, diffraction gratings, arrayed waveguides, etc. can be employed used in the combiners 32 and distributors 34. The multi-port devices can be used alone, or in various combinations of filters, such tunable or fixed, high, low, or band pass or band stop, transmissive or reflective filters, such as Bragg gratings, Fabry-Perot, Mach-Zehnder, and dichroic filters, etc. Furthermore, one or more serial or parallel stages incorporating various multi-port device and filter combinations can be used in the combiners 32 and distributors 34 to multiplex, demultiplex, and multi-cast signal wavelengths λᵢ in the optical systems 10.

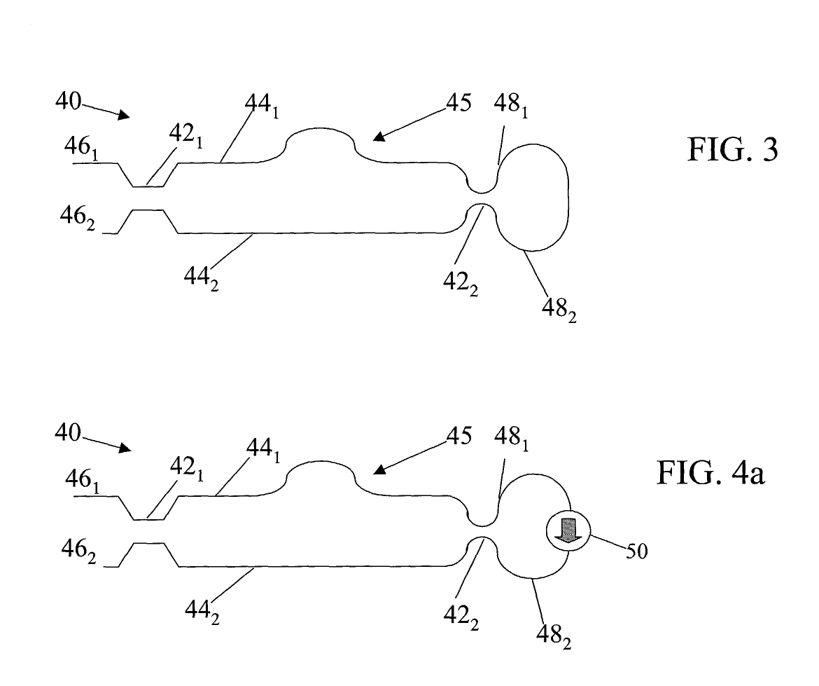

FIG. 3 illustrates a double pass Mach Zehnder (“DPMZ”) filter 40, which can be deployed in the system 10 of the present invention. The double pass Mach-Zehnder filter 40 includes at least first and second optical coupling sections, e.g., 42₁ and 42₂, interconnected by first and second ends of at least two optical communication paths, or Mach-Zehnder legs, e.g., 44₁ and 44₂, which together defines a Mach-Zehnder interferometer. The first coupling section 42₁ includes one or more input/output (I/O) ports, e.g., 46₁, and 46₂, and the second coupling section 42₂ includes first and second output/input (O/I) ports, 48₁ and 48₂, respectively.

The double pass Mach-Zehnder filter 40 can be constructed from various waveguide material, such as described with respect to the transmission media 16. For example, the double pass Mach-Zehnder filter 40 can be a fiber-based or planar device and include free space components as will be described.

As further shown in FIG. 3, the output/input ports, 48₁ and 48₂, are connected optically, such that optical energy, or signals, exiting at least one of the O/I ports 48 from the Mach-Zehnder legs 44 will be provided as input into the other O/I port. For example, signals exiting the second coupling section 42₂ from the Mach-Zehnder legs 44 via the first O/I port 48₁ will reenter the second coupling section 42₂ via the second O/I port 48₂. The converse occurs for those signals exiting the Mach-Zehnder legs 44 via second O/I port 48₂.

The Mach-Zehnder legs, 44₁ and 44₂, are designed to introduce an effective path length difference, or mismatch, between the first and second coupling section, 42₁ and 42₂. The effective path length difference can be a physical difference in that one path, e.g., fiber length, is longer than the other path. Alternatively, the path length difference can be induced by varying the waveguide properties of the communication paths, such as refractive index, temperature, strain, electric and magnetic fields, etc. to induce an effective path length difference.

The mismatch produces constructive and/or destructive interference of optical energy introduced into the coupling sections 42 as a periodic function of wavelength. The mismatch defines a filter function based on the wavelength periodicity, wherein the transmission T_{SP} through the Mach-Zehnder interferometer and the frequency period P_{ν}can be described by the equation:

T_{SP}=cos ²(αΔL/2), and

P_{ν}=c/(nΔL), respectively, where

α=propagation constant through the transmission media 16;

ΔL=path length difference between the Mach-Zehnder legs, 44₁ and 44₂;

c=speed of light; and,

n=refractive index of the transmission media 16 comprising the Mach-Zehnder legs 44.

In the present invention, optical energy is double passed through the Mach-Zehnder interferometer, such that the effective filter function T_{DP} is the square of the filter function T_{SP} for a single pass through the Mach-Zehnder interferometer or

T_{DP=cos} ⁴(αΔL/2)

In FIG. 3 embodiments, optical energy introduced into the double pass Mach-Zehnder 40 via the first input/output 46₁ port will be output from the first output/input port 48₁ according to the function T_{SP}. The output from the second input/output port 48₂ is according to the complementary function 1−T_{SP}.

If the optical energy exiting the output/input port 48 is introduced back into the other output/input port 48 without alteration, the optical energy will exit the second input/output 46₂ port substantially as it entered the first input/output 46₁ port. The separation followed by recombination of the optical energy as it passes through the double pass Mach-Zehnder filter allows various filtering and/or monitoring functions to be performed, as will be described further. For example, monitoring equipment, such as photodiodes, optical spectrum analyzers, etc., can be deployed between the output/input ports 48 in the FIG. 3 embodiment. The monitoring equipment can monitor the separated optical energy, thereby providing finer granularity during monitoring and decreasing monitoring equipment specifications without disrupting the overall signal.

In various embodiments, isolators, circulators, and other wavelength or non-wavelength selective isolation and/or reflective devices can be used to provide only one signal output from the output/input ports 48 as a second pass input to the output/input ports 48. In this manner, wavelengths transmitted to one of the output/input ports can be selectively filtered by the filter 40.

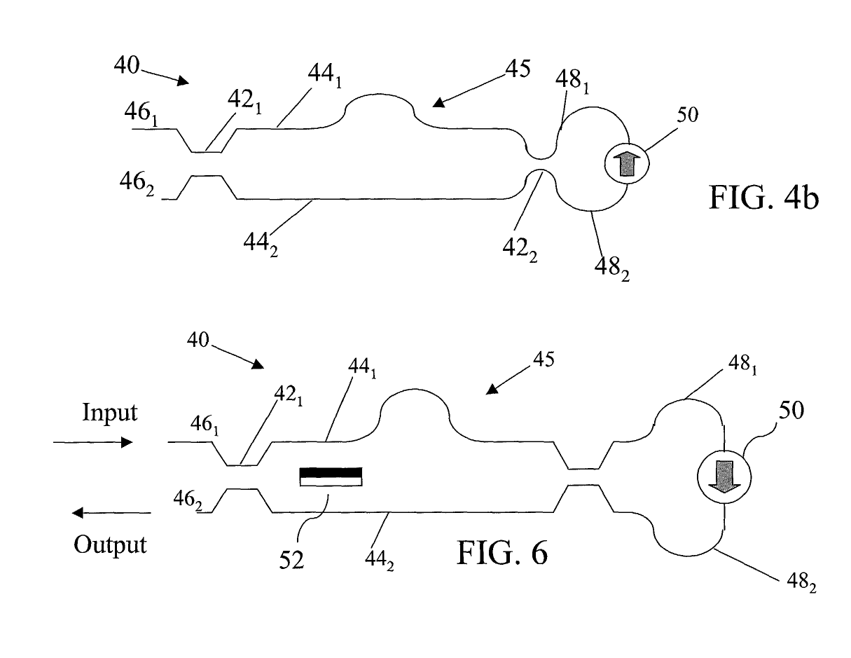

FIGS. 4a-b show double pass Mach-Zehnder embodiments, in which an isolator 50 is provided to prevent optical energy exiting the second output/input port 48₂ from entering the first output/input port 48₁ (FIG. 4a). The opposite occurring in FIG. 4b embodiments. Thus, in FIG. 4a, only optical energy exiting first output/input port 48₁ will exit the double pass Mach-Zehnder filter 40 via the second input/output port 46₂. If the optical energy enters the double pass Mach-Zehnder filter 40 via the first input/output port 46₁, the optical energy will be filtered with the transmitted energy and the will exit the double pass Mach-Zehnder filter 40 via the second input/output port 46₂. The opposite being true for optical energy entering the second input/output port 46₂.

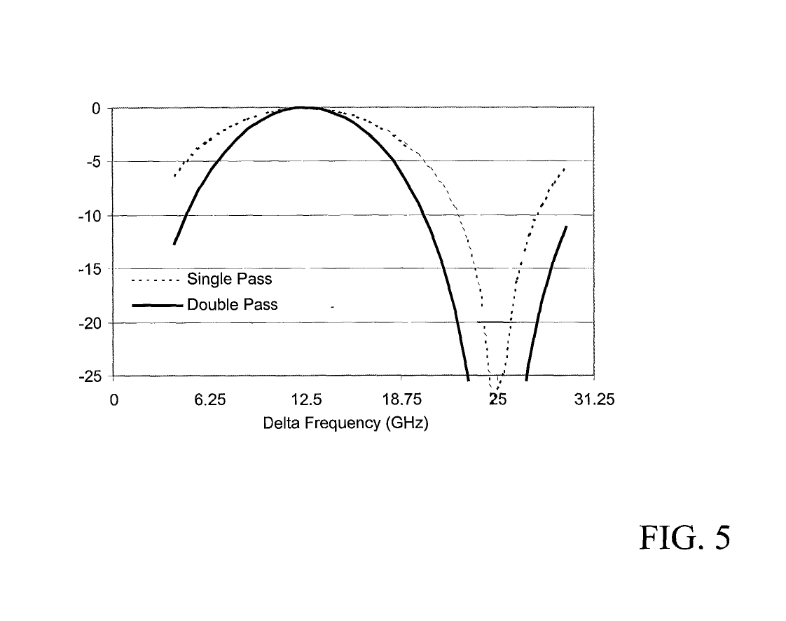

FIG. 5 shows a double pass Mach-Zehnder filter function along with its corresponding single pass filter function for embodiments such as those shown in FIG. 4b. The double pass Mach-Zehnder filter provides a filter function, in which the transmission is a much stronger function of frequency than the single pass filter. The filter function of the double pass Mach-Zehnder filter increases it effectiveness as a filter, because the slope of the transmission function provides for increased isolation between the peak transmission wavelengths. In this manner, the double pass Mach-Zehnder filter of the present invention reduces the free spectral range and increase the isolation of the filter, while maintaining the frequency periodicity of the filter.

The filter characteristics of the double pass Mach-Zehnder filter depend upon the length mismatch between the legs of the double pass Mach-Zehnder filter as described by the above transmission and frequency period equations. As such, the length mismatch between the Mach-Zehnder legs 44 can be used to control the filter performance and the desired output port of the filter 40 by varying the relative distribution of the signal between the output ports.

The Mach-Zehnder interferometer of the present invention can have a fixed path length mismatch or it can be tunable depending upon the particular application for the filter. For example, various tuning methods, such as temperature, strain, electrical field, etc., can be used to maintain, change, and/or otherwise control the filter function.

FIG. 6 further shows the use of a tuning element 52 positioned relative to the longer Mach-Zehnder leg 44₁. The tuning element 52 can include thermal tuning elements, for example, resistive heaters, heat pipes, thermo-electric coolers (“TEC”), Peltier elements, etc., as well as other types of tuning elements, such as strain, electric, magnetic, etc. The tuning element 52 can be positioned in various locations relative to the Mach-Zehnder legs 44, as well as the coupling sections 42. For example, tuning elements 52 can be used to control the individual temperatures of the legs 44, or a single temperature control element 52 can be used to maintain both legs 44 at the same temperature. One of ordinary skill will appreciate that the selection of input and output ports and the relationship to the longer Mach-Zehnder leg 44₁ and the location of isolators, tuning elements, etc. can be made to achieve various filtering objectives.

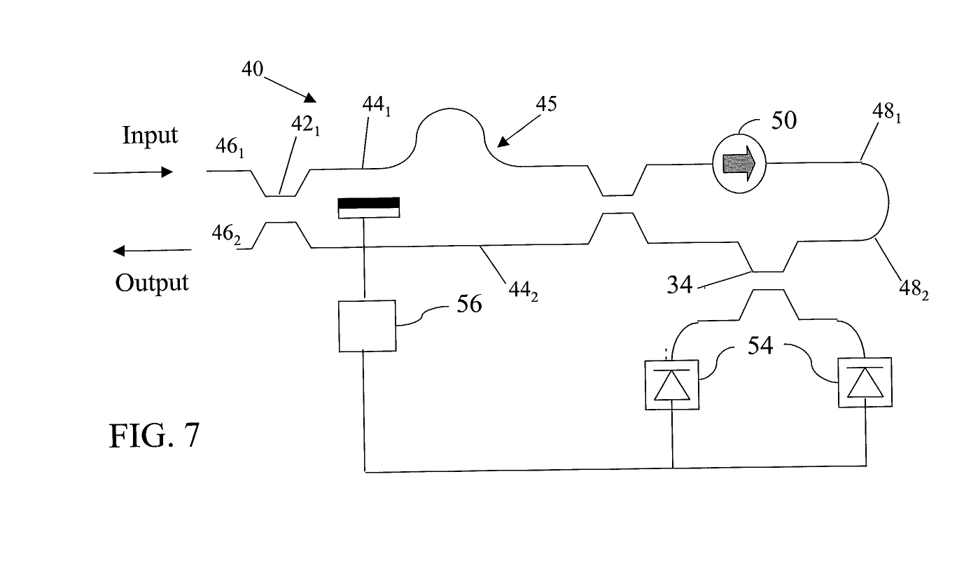

FIG. 7 shows an embodiment incorporating an optical distributor 34, typically a low ratio, non-wavelength selective splitter. The distributor 34 is used to tap off a portion of the optical energy exiting one or more of the output/input ports 48 as a monitoring signal. Photodiodes 54, or other optical to electrical converters, can be used to monitor the total optical energy or a wavelength selective distributor 34 or filter can be used to monitor only selected wavelengths.

As further shown in FIG. 7, a filter controller 56 can be employed to control the Mach-Zehnder leg length mismatch and the resulting filter characteristics of the double pass Mach-Zehnder filter 40 based on the monitoring signal. The filter controller 56 can include various combinations of analog and digital controllers, as well as feedback loops, to control one or more of the temperature control elements 52. The filter controller 56 can control the tuning element 52 based on the monitoring signal provided by the monitoring photodiodes.

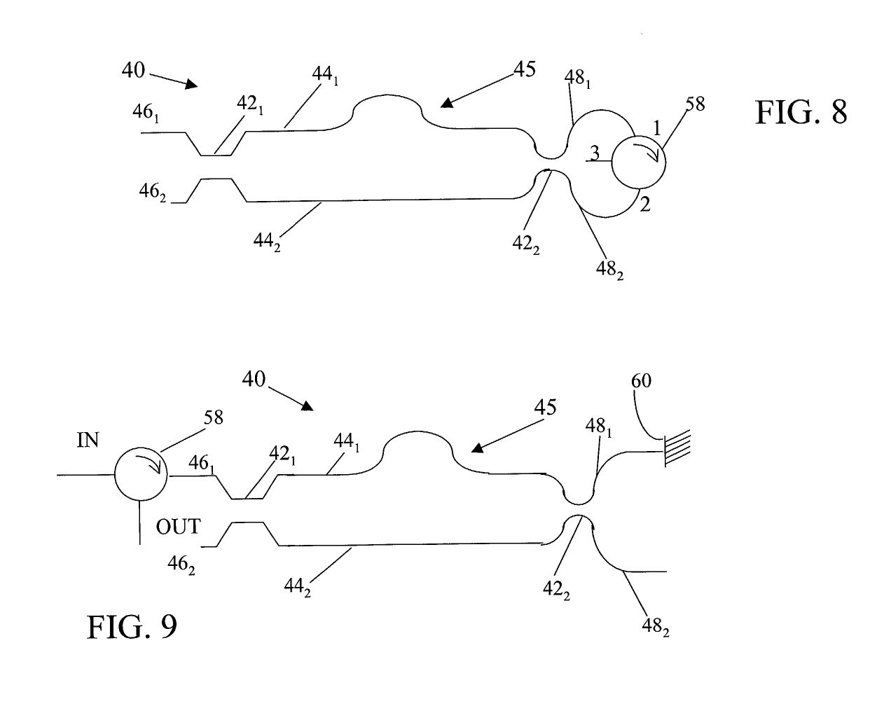

FIG. 8 shows the use of a circulator 58 in place of the isolator 50 to prevent the optical energy exiting the second output/input port 48₂ from passing back through the Mach-Zehnder interferometer. A three port circulator 58 is shown in FIG. 8, although circulators 58 with different numbers of ports can be used. In addition, the optical energy that exits the second output/input port 48₂ can be monitored as it exits port 3 of the circulator 58.

FIG. 9 shows a double pass Mach-Zehnder filter embodiment in which at least one of the output/input ports 48 are coupled to reflective mirrors 60, or other non-wavelength selective devices. The mirrors 60 reflect the optical energy exiting the output/input ports 48 back through the Mach-Zehnder interferometer. A circulator 58 can be provided at the input/output port 46 to separate input and output signals.

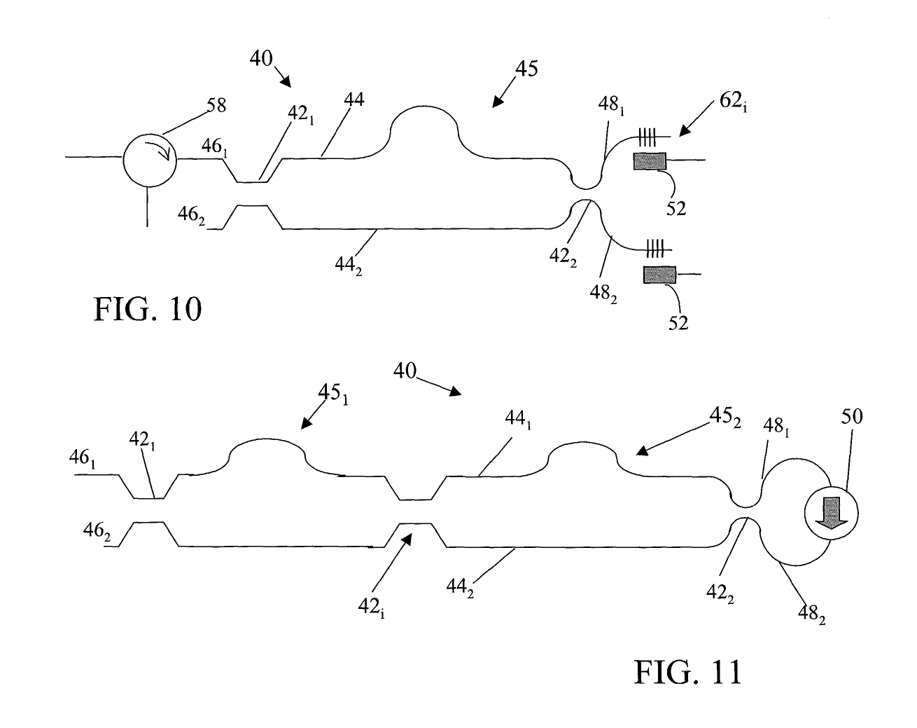

Similarly, FIG. 10 shows the use of fiber Bragg gratings (“FBGs”) 62 as wavelength selective reflectors, in lieu of the mirrors depicted in FIG. 9. As with the mirrors, it will be appreciated that one or more types of wavelength selective reflectors can be coupled to one or more of the output/input ports 48 depending upon the desired filter characteristics. In addition, tunable wavelength selective reflective devices can be used, for example, by including a tuning element 52, to provide wavelength tuning capability, in addition to that association with the Mach-Zehnder legs.

FIG. 11 is demonstrative of double pass Mach-Zehnder filter 40 embodiments that include concatenated Mach-Zehnder interoferometers. The concatenated Mach-Zehnder embodiments include one or more intermediate coupling sections 42_{I} disposed along the communication paths 44 between the first and second coupling sections, 42₁ and 42₂, respectively. In these embodiments, multiple Mach-Zehnder interferometers, usually having different filtering characteristics, e.g. periods, are coupled in series to provide a combined filter function.

The double pass Mach-Zehnder device 40 of the present invention can be used in various components and subsystems within a system. For example, the device can be used to perform filtering functions in various components, subsystems, and network elements, including transmitters, receivers, multiplexers, demultiplexers, switches, add/drop multiplexers, etc.

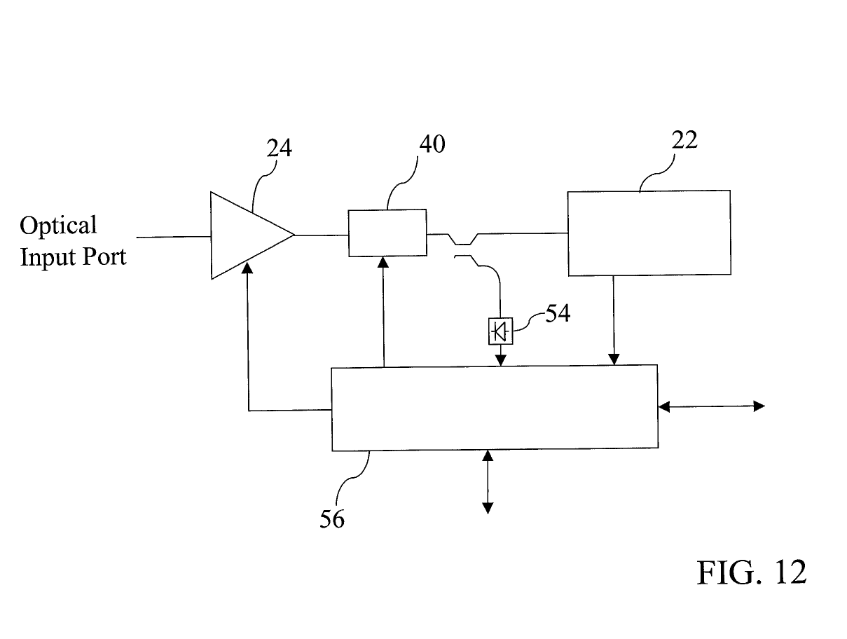

For example, FIG. 12 shows the double pass Mach-Zehnder filter 40 used in combination with an optical amplifier 24, a monitoring photodiode 54, and a receiver 22. In these embodiments, monitoring signal from the photodiode 54 and/or the receiver 22 can be used by the filter controller to control the double pass Mach-Zehnder filter 40 and/or the optical amplifier. It will be appreciated that the amplifier 24, double pass Mach-Zehnder filter 40, and photodiode 54 can be placed on one or more line cards within a subsystem or network element, or in separate network elements in various manners.

In other embodiments, the double pass Mach-Zehnder filters 40 can be used in a reconfigurable optical networks. For example, in all-optical network or subnetwork embodiments, tunable filter 40 can be used in combination with various optical components, such as transmitters, receivers, and optical switching devices, to provide reconfigurable signal wavelengths transmission paths through the network.

It will be appreciated that the present invention provides for improved optical filters for use with optical components, subsystems, and systems. Those of ordinary skill in the art will further appreciate that numerous modifications and variations that can be made to specific aspects of the present invention without departing from the scope of the present invention. It is intended that the foregoing specification and the following claims cover such modifications and variations.

What is claimed is:

1. An apparatus comprising:
a first optical coupling section coupling at least one input/output port to a first end of at least two optical communication paths having different effective lengths; and,
a second optical coupling section coupling at least one output/input port to a second end of said at least two optical communication paths, wherein said at least one output/input port is coupled optically to at least one of said at least one output/input ports.

2. The apparatus of claim 1, wherein said at least one output/input port includes a first output/input port and a second output/input port, wherein said first output/input port and said second output/input port are coupled optically.

3. The apparatus of claim 2, wherein said first output/input port and said second output/input port are coupled optically through at least one of an optical isolator and an optical circulator.

4. The apparatus of claim 1, wherein said at least one output/input port is coupled to a reflective element.

5. The apparatus of claim 4, wherein said reflective element is configured to reflect at least a portion of an optical signal passing from said second coupling section through said output/input port back through said output/input port and said second coupling section.

6. The apparatus of claim 4, wherein said apparatus includes an optical circulator optically coupled to said input/output port.

7. The apparatus of claim 4, wherein said reflective element includes at least one of a wavelength selective reflective element and a non-wavelength selective reflective element.

8. The apparatus of claim 4, wherein said reflective element includes at least one Bragg grating.

9. The apparatus of claim 8, wherein apparatus includes a tuning element cooperating with at least one of said Bragg gratings.

10. The apparatus of claim 4, wherein said reflective element includes at least one mirror.

11. The apparatus of claim 1, wherein said apparatus includes an optical circulator optically coupled to said input/output port.

12. The apparatus of claim 1, wherein said apparatus includes a tuning element positioned proximate at least one of said optical communication paths.

13. The apparatus of claim 1, wherein said apparatus includes a tuning element positioned proximate at least one of said optical communication paths.

14. The apparatus of claim 13, wherein said apparatus includes a filter controller configured to control said tuning element in response to a monitoring signal.

15. The apparatus of claim 1, wherein said apparatus includes at least one intermediate coupling section between said first and second coupling sections, wherein said optical communication paths are coupled through said intermediate coupling to provide at least one path length difference between said communication paths.

16. The apparatus of claim 15, wherein a path length difference between said communication paths is provided between said first coupling section and said intermediate coupling section and between said intermediate coupling section and said second coupling section.

17. The apparatus of claim 15, wherein said apparatus includes a plurality of intermediate coupling sections.

18. The apparatus of claim 1, wherein said communication paths having different physical lengths.

19. A method of filtering optical signals comprising:
providing a Mach-Zehnder interferometer having at least one input/output port and at least one output/input port;
introducing an optical signal into the at least one input/output port to provide a single pass output from the at least output/input port; and,
introducing the single pass output into at least one of the output/input port to provide a double pass output from at least one of the input/output ports.

20. The method of claim 19, wherein said introducing includes introducing only one of the single pass outputs from the at least one of the output/input port back into one of the input/output ports.

21. An optical system comprising:
at least one transmitter;
at least one receiver; and,
an optical filter including a first optical coupling section coupling at least one input/output port to a first end of at least two optical communication paths having different lengths, and
a second optical coupling section coupling at least one output/input port to a second end of said at least two optical communication paths, wherein said at least one output/input port is coupled to at least one of said at least one output/input ports.

22. The system of claim 21, wherein said system includes at least one of an optical amplifier, optical switch, optical add/drop multiplexer, and interfacial device.

23. The system of claim 21, wherein said system includes:
a plurality of optical transmitters; and,
a plurality of optical receivers.

24. The system of claim 21, wherein said system includes at least one of an optical combiner and optical distributor.

25. The system of claim 21, wherein said system is a reconfigurable optical network.
